(19) United States
(12) Patent Application Publication
(10) Pub. No.: US 2021/0043979 A1
(43) Pub. Date: Feb. 11, 2021

(54) NON-AQUEOUS ELECTROLYTE SECONDARY BATTERY

(71) Applicant: Toyota Jidosha Kabushiki Kaisha, Toyota-shi (JP)

(72) Inventors: Yoshinori KUDO, Toyota-shi (JP); Yasushi TSUCHIDA, Nisshin-shi (JP); Masaki KATO, Toyota-shi (JP)

(73) Assignee: Toyota Jidosha Kabushiki Kaisha, Toyota-shi (JP)

(21) Appl. No.: 16/919,523

(22) Filed: Jul. 2, 2020

(30) Foreign Application Priority Data
Aug. 5, 2019 (JP) 2019-143926

(51) Int. Cl. H01M 10/0587; H01M 10/0525; H01M 10/0585; H01M 2/16; H01M 4/133; H01M 4/1393; H01M 4/36

(52) U.S. Cl. CPC H01M 10/0587; H01M 10/0525; H01M 10/0585; H01M 2300/0017; H01M 4/133; H01M 4/1393; H01M 4/366; H01M 2/1673

(57) ABSTRACT

A non-aqueous electrolyte secondary battery including positive and negative electrodes, and a non-aqueous electrolyte. The positive electrode includes a positive electrode current collector, a positive electrode active material layer formed on the positive electrode current collector except for the positive electrode current collector's exposed part, and an insulating layer formed at a boundary part between the positive electrode current collector's exposed part and the positive electrode active material layer. The positive electrode active material layer includes a main body part and an end having a smaller thickness than the main body part. The insulating layer is between the positive electrode current collector and the end and covers the end. A width La of the positive electrode active material layer and a width Lb of a part of the insulating layer between the positive electrode current collector and the end satisfy the formula:

0.02×10⁻²≤(Lb/La)≤2.1×10⁻².

### CROSS REFERENCE TO RELATED APPLICATION

This application claims the benefit of priority to Japanese Patent Application No. 2019-143926 filed on Aug. 5, 2019. The entire contents of this application are hereby incorporated herein by reference.

### BACKGROUND OF THE DISCLOSURE

### 1. Field

The present invention relates to a non-aqueous electrolyte secondary battery.

### 2. Background

Generally, a non-aqueous electrolyte secondary battery includes a positive electrode having a positive electrode active material layer, a negative electrode which faces the positive electrode and has a negative electrode active material layer wider than the positive electrode active material layer, and a non-aqueous electrolyte containing charge carriers. The positive electrode of the non-aqueous electrolyte secondary battery includes a positive electrode current collector and the positive electrode active material layer provided on the positive electrode current collector. For example, in order to collect electricity, the positive electrode current collector may have a part in which no positive electrode active material layer is provided and the positive electrode current collector is exposed (an exposed part of the positive electrode current collector) at at least one end. In connection with this, Japanese Patent Application Publication No. 2017-157471 discloses a positive electrode including a positive electrode current collector, a positive electrode active material layer that is provided on the positive electrode current collector except for an exposed part of a positive electrode current collector, and an insulating layer that is provided at a boundary part between the exposed part of the positive electrode current collector and the positive electrode active material layer.

### SUMMARY

However, according to studies by the inventors, in the configuration, metal deposition occurs on a negative electrode and cycle characteristics deteriorate in some cases. That is, in Japanese Patent Application Publication No. 2017-157471, a negative electrode active material layer is wider than a positive electrode active material layer, and an end side surface of a positive electrode active material layer is exposed without being covered with an insulating layer. Therefore, a current and charge carriers are likely to concentrate at an end of a positive electrode active material layer. However, during charging and discharging, generally, a battery voltage is controlled by a difference between a potential of the entire positive electrode and a potential of the entire negative electrode, that is, an average value. Therefore, the end of the positive electrode active material layer is more likely to be exposed to a higher potential than a part of a main body of the positive electrode active material layer. Therefore, when charging and discharging are repeated, metallic elements (for example, charge carriers and transition metal elements constituting a positive electrode active material) are easily eluted from the end of the positive electrode. As a result, metal deposition occurs at a part that faces the end of the negative electrode, and the battery capacity after cycling is reduced.

The present invention has been made in view of the above circumstances, and an object of the present invention is to provide a non-aqueous electrolyte secondary battery in which metal deposition on a negative electrode is minimized and cycle characteristics are improved.

According to the present invention, provided is a non-aqueous electrolyte secondary battery including a positive electrode, a negative electrode that faces the positive electrode, and a non-aqueous electrolyte. The positive electrode includes a positive electrode current collector, a positive electrode active material layer which contains a positive electrode active material and is formed on the positive electrode current collector except for a part in which the positive electrode current collector is exposed and an insulating layer which contains an inorganic filler and is formed at a boundary part between the part in which the positive electrode current collector is exposed and the positive electrode active material layer. The positive electrode active material layer includes a main body part and an end part which is provided closer to the part in which the positive electrode current collector is exposed than the main body part and has a smaller thickness than a thickness of the main body part. The insulating layer is inserted between the positive electrode current collector and the end part in a thickness direction and is formed so as to cover the end part. When a width of the positive electrode active material layer is set as La, and a width of a part of the insulating layer inserted between the positive electrode current collector and the end part is set as Lb in a direction from the positive electrode active material layer to the insulating layer, the width La and the width Lb satisfy the following Formula (1): 0.02×10⁻²≤(Lb/La)≤2.1×10⁻².

In the configuration, the insulating layer is inserted between the positive electrode current collector and the end part of the positive electrode active material layer and also covers the end part of the positive electrode active material layer. Therefore, supply of electrons from the positive electrode current collector to the end part of the positive electrode active material layer is minimized, and a charging and discharging reaction is unlikely to occur at the end part of the positive electrode active material layer. Therefore, movement of charge carriers from the end is restricted. As a result, the end part of the positive electrode active material layer is less likely to be exposed to a high potential, and it is possible to minimize elution of metallic elements from the positive electrode active material at the end part. As a result, it is possible to reduce metal deposition (for example, Li deposition) on the negative electrode and it is possible to realize a battery having excellent durability.

In one preferable aspect of the non-aqueous electrolyte secondary battery disclosed here, the width La and the width Lb satisfy the following Formula (2): 0.02×10⁻²≤(Lb/La)≤1.0×10⁻². According to such a configuration, it is possible to effectively minimize elution of metallic elements from the end part of the positive electrode active material layer and also it is possible to minimize an increase in resistance due to formation of the insulating layer.

In one preferable aspect of the non-aqueous electrolyte secondary battery disclosed here, the width Lb is 20 μm or more and 2,000 μm or less. According to such a configuration, it is possible to effectively minimize elution of metallic elements from the end part of the positive electrode active material layer and also it is possible to suitably realize a large battery capacity.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view showing a lithium ion secondary battery according to an embodiment of the present invention;

FIG. 2 is a schematic view showing a configuration of a wound electrode body according to an embodiment of the present invention.

FIG. 3 is a schematic cross-sectional view showing a configuration of a positive electrode.

FIG. 4 is an explanatory diagram for describing movement of electrons and Li.

FIG. 5 is a graph showing the relationship between a viscosity ratio of pastes and Lb/La.

FIG. 6 is a graph showing the relationship between Lb/La and the amount of Mn in a negative electrode after cycles.

FIG. 7 is a graph showing the relationship between Lb/La and durability after high rate cycling.

### DETAILED DESCRIPTION OF THE PREFERRED EMBODIMENTS

Hereinafter, some embodiments of the technology disclosed here will be described. Here, of course, the embodiments described here are not intended to limit the technology disclosed here. Components other than those particularly mentioned in this specification that are necessary for implementing the technology disclosed here (for example, a general configuration and a production process of a non-aqueous electrolyte secondary battery that does not characterize the technology disclosed here) can be recognized by those skilled in the art as design matters based on the related art in the field. The technology disclosed here can be implemented based on content disclosed in this specification and common general technical knowledge in the field.

Here, in this specification, “secondary battery” generally refers to a power storage device that can be repeatedly charged and discharged. For example, a lithium ion secondary battery, a nickel metal hydride battery, a lithium ion capacitor, an electric double layer capacitor, and the like are typical examples included in the secondary battery here. In addition, in this specification, “lithium ion secondary battery” refers to a secondary battery in which lithium ions are used as charge carriers, and charging and discharging are realized when lithium ions move between positive and negative electrodes. Here, in this specification, the notation “A to B” (A and B are any numerical values) indicating a range means “A or more and B or less” and also “preferably larger than A” and “preferably smaller than B.”

Although not intended as a particular limitation, a lithium ion secondary battery will be exemplified in detail below. In the following drawings, members and portions having the same functions are denoted by the same reference numerals, and redundant descriptions thereof will be omitted or simplified. In addition, symbols X and Y in the drawings represent a thickness direction and a width direction of an electrode body. Symbols X and Y intersect (orthogonal here) each other in a plan view. The width direction Y is an example of a direction from a positive electrode active material layer to an insulating layer. In addition, along the width direction Y, one direction may be referred to as a Y1 direction, and the opposite direction may be referred to as a Y2 direction. However, these directions are only directions determined for convenience of description and do not limit an installation form of a lithium ion secondary battery at all.

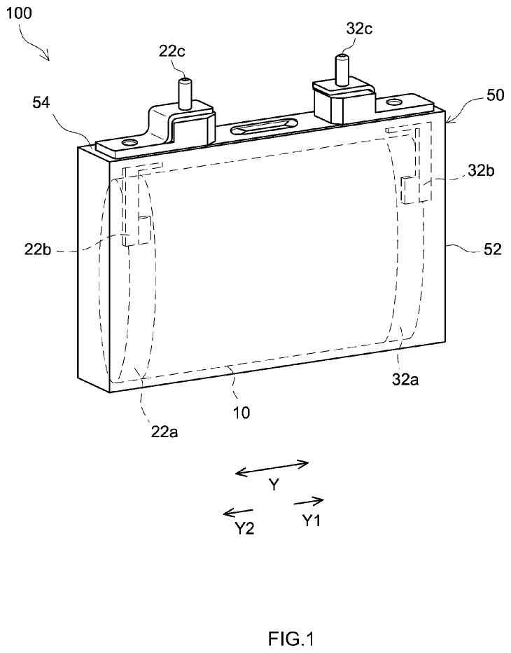

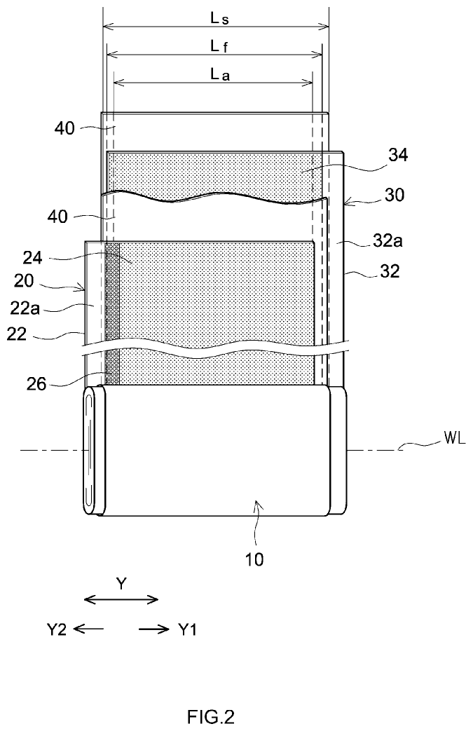

FIG. 1 is a perspective view schematically showing a lithium ion secondary battery 100. The lithium ion secondary battery 100 includes a flat wound electrode body 10 (refer to FIG. 2), a non-aqueous electrolyte (not shown), and a flat rectangular battery case 50. The battery case 50 is an exterior container in which the wound electrode body 10 and the non-aqueous electrolyte are accommodated. Regarding the material of the battery case 50, for example, a lightweight metal material having favorable thermal conductivity such as aluminum is suitable. The battery case 50 includes a case main body 52 having a bottomed rectangular parallelepiped shape having an opening and a lid (sealing plate) 54 that closes the opening. The lid 54 is a rectangular plate member. A positive electrode terminal 22c and a negative electrode terminal 32c for external connection protrude upward from the lid 54.

FIG. 2 is a schematic view showing the wound electrode body 10. As shown in FIG. 2, the wound electrode body 10 has a configuration in which a band-like positive electrode 20 and a band-like negative electrode 30 are laminated with a band-like separator 40 therebetween, and wound in a longitudinal direction about a winding axis WL. The wound electrode body 10 has a flat shape and has an elliptical shape in a cross section in the width direction Y.

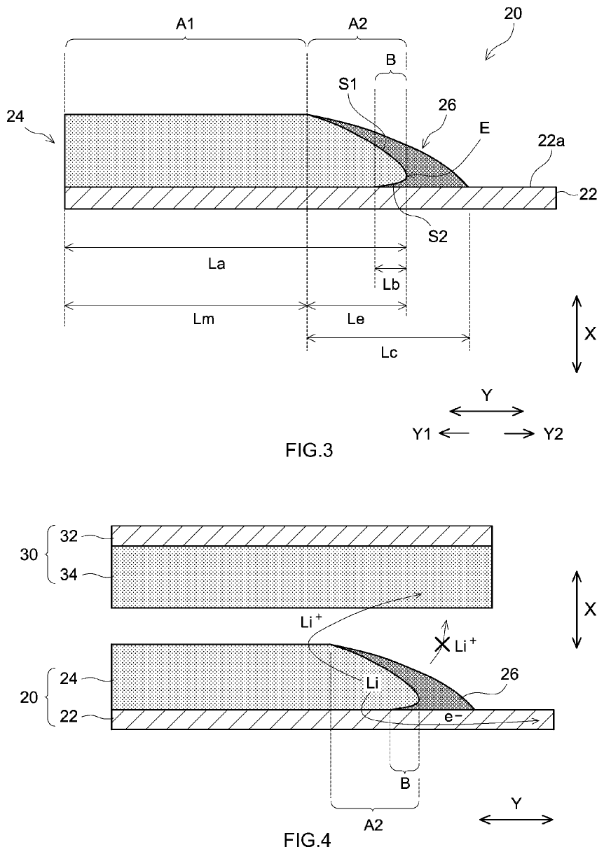

FIG. 3 is a schematic cross-sectional view showing a configuration of the positive electrode 20. Here, FIG. 3 shows a state in which the width direction Y is inverted with respect to that of FIGS. 1 and 2. The positive electrode 20 includes a positive electrode current collector 22, a positive electrode active material layer 24 that is formed on the positive electrode current collector 22, and an insulating layer 26 that is formed on the positive electrode current collector 22. Here, the positive electrode active material layer 24 and the insulating layer 26 may be provided on only one surface of the positive electrode current collector 22 or may be provided on both surfaces of the positive electrode current collector 22. The positive electrode current collector 22 is a conductive member. Regarding the positive electrode current collector 22, for example, a metal foil of aluminum, nickel, or the like is suitable. The positive electrode current collector 22 may be subjected to a conventionally known surface treatment, for example, an etching treatment, a hydrophilic treatment, or various kinds of coatings.

The positive electrode current collector 22 has a part 22a in which the insulating layer 26 and the positive electrode active material layer 24 are not formed and the positive electrode current collector 22 is exposed (hereinafter referred to as an “exposed part of the positive electrode current collector”). Here, the exposed part 22a of the positive electrode current collector is provided in a band shape at an end part of the positive electrode current collector 22 in the Y2 direction. However, the exposed part 22a of the positive electrode current collector may be provided at an end part in the Y1 direction, or may be provided at both end parts in the width direction Y. As shown in FIG. 2, the exposed part 22a of the positive electrode current collector protrudes in the Y2 direction relative to the end part of the negative electrode 30 (for example, a negative electrode active material layer 34) in the Y2 direction in a plan view. As shown in FIG. 1, a positive electrode current collecting plate 22b is bonded to the exposed part 22a of the positive electrode current collector. The positive electrode current collecting plate 22b is electrically connected to the positive electrode terminal 22c.

As shown in FIG. 3, the positive electrode active material layer 24 is fixed onto the surface of the positive electrode current collector 22 and onto the surface of a part of the insulating layer 26. The positive electrode active material layer 24 contains a positive electrode active material that can reversibly occlude and release charge carriers. Examples of positive electrode active materials include lithium transition metal oxides such as a lithium- and nickel-containing composite oxide, a lithium- and cobalt-containing composite oxide, a lithium-, nickel- and cobalt-containing composite oxide, a lithium- and manganese-containing composite oxide, and a lithium-, nickel-, cobalt- and manganese-containing composite oxide. These can be used alone or two or more thereof can be used in combination. In particular, when a lithium- and manganese-containing composite oxide containing manganese that is easily eluted is used, application of the technology disclosed here is preferable. When the total solid content of the positive electrode active material layer 24 is set as 100 mass %, a proportion of the positive electrode active material may be about 50 mass % or more, for example, 80 mass % or more.

The positive electrode active material layer 24 may contain optional components other than the positive electrode active material, for example, a conductive material, a dispersant, a binder, lithium phosphate, and various additive components. Regarding the conductive material, for example, carbon black such as acetylene black (AB) and other carbon materials can be used. Regarding the binder, for example, polyvinylidene fluoride (PVdF) can be used.

As shown in FIG. 2, the positive electrode active material layer 24 extends in the longitudinal direction with a predetermined width La. Although not particularly limited, the width La may be about 20 to 500 mm, typically 30 to 200 mm, for example, 40 to 150 mm. The positive electrode active material layer 24 is formed in a band shape along an end of the positive electrode current collector 22 in the Y1 direction. The positive electrode active material layer 24 is positioned in the Y1 direction relative to the insulating layer 26. The entire positive electrode active material layer 24 overlaps the negative electrode active material layer 34 in a plan view. The entire positive electrode active material layer 24 overlaps the separator 40 in a plan view.

As shown in FIG. 3, the positive electrode active material layer 24 includes a main body part A1, and an end part A2 which is provided closer to the exposed part 22a of the positive electrode current collector than the main body part A1 and includes an end E of the positive electrode active material layer 24 in the Y2 direction. The main body part A1 is formed on the surface of the positive electrode current collector 22. The main body part A1 is in contact with the surface of the positive electrode current collector 22. The main body part A1 has a substantially constant thickness. Although not particularly limited, the average thickness of the main body part A1 may be about 10 to 200 μm, typically 20 to 150 μm, for example, 40 to 100 μm. Here, the main body part A1 includes the center of the positive electrode active material layer 24 in the width direction Y. The main body part A1 has a width Lm in the width direction Y.

The end part A2 extends from the main body part A1 in the Y2 direction. The end part A2 is formed at least on the surface of the insulating layer 26. The end part A2 is laminated on the insulating layer 26. Here, the end part A2 is formed on the surface of the insulating layer 26 from the surface of the positive electrode current collector 22. The end part A2 has a width Le in the width direction Y. Generally, the width Le is shorter than the width Lm of the main body part A1. Although not particularly limited, the width Le may be about 10 μm or more, typically 20 to 10,000 μm, for example, 30 to 5,000 μm, and preferably 50 to 3,000 μm. A ratio (Le/Lm) of the width Le of the end part A2 with respect to the width Lm of the main body part A1 may be about 0.1 or less, typically 0.01 to 0.05, for example, 0.015 to 0.03, or 0.02 to 0.025. Thereby, it is possible to minimize metal deposition on the negative electrode 30 to a large degree and also it is possible to provide a large battery capacity. In addition, it is possible to form the end part A2 with a stable width.

The end part A2 is not exposed in a plan view. In a cross-sectional view, the end part A2 includes an inclined surface S1 whose thickness continuously decreases toward the end part of the positive electrode current collector 22 in the Y2 direction and an inclined surface S2 whose thickness continuously decreases toward the end part of the positive electrode current collector 22 in the Y1 direction, in contrast to the inclined surface S1. The inclined surface S1 and the inclined surface S2 are completely covered with the insulating layer 26.

The insulating layer 26 is fixed to the surface of a part of the positive electrode active material layer 24 (specifically, the end part A2) from the surface of the positive electrode current collector 22. The insulating layer 26 contains an inorganic filler. Examples of positive electrode active materials include lithium transition metal oxides such as a lithium- and nickel-containing composite oxide, a lithium- and cobalt-containing composite oxide, a lithium-, nickel- and cobalt-containing composite oxide, a lithium- and manganese-containing composite oxide, and a lithium-, nickel-, cobalt- and manganese-containing composite oxide. These can be used alone or two or more thereof can be used in combination. Among these, a lithium-, nickel-, cobalt- and manganese-containing composite oxide having a layered rock salt type structure is preferable. When the total solid content of the insulating layer 26 is set as 100 mass %, a proportion of the positive electrode active material may be about 50 mass % or more, for example, 80 mass % or more.

The insulating layer 26 may contain optional components other than the inorganic filler, for example, a binder and various additive components. Regarding the binder, for example, a polyolefin binder such as polyethylene (PE), polyvinylidene fluoride (PVdF), polytetrafluoroethylene (PTFE), an acrylic resin, styrene butadiene rubber (SBR), or the like can be used. The binder may be of the same type as or a different type from the binder of the positive electrode active material layer 24.

As shown in FIG. 2, the insulating layer 26 extends in the longitudinal direction. The insulating layer 26 is positioned at the boundary part between the positive electrode active material layer 24 and the exposed part 22a of the positive electrode current collector in the width direction Y. The insulating layer 26 protrudes in the Y2 direction relative to an end of the negative electrode 30 (for example, the negative electrode active material layer 34) in the Y2 direction in a plan view. The entire insulating layer 26 overlaps the separator 40 in a plan view. As shown in FIG. 3, the insulating layer 26 is positioned between the main body part A1 of the positive electrode active material layer 24 and the exposed part 22a of the positive electrode current collector in the width direction Y. The insulating layer 26 is formed in a band shape along an end of the main body part A1 in the Y2 direction. The insulating layer 26 is positioned in the Y2 direction relative to the main body part A1. The insulating layer 26 has a predetermined width Lc. Here, the width Lc is longer than the width Le of the end part A2 of the positive electrode active material layer 24. However, the width Lc may be the same as the width Le of the end part A2 of the positive electrode active material layer 24.

As shown in FIG. 3, in a cross-sectional view, the insulating layer 26 is overlaid on the inclined surface S1 of the positive electrode active material layer 24. Here, no other layers such as the positive electrode active material layer 24 are laminated on the insulating layer 26. The insulating layer 26 is exposed on the surface of the positive electrode 20. In addition, in a cross-sectional view, the insulating layer 26 is inserted between the positive electrode current collector 22 and the inclined surface S2 of the positive electrode active material layer 24. Here, the width Lb of a part of the insulating layer 26 inserted between the positive electrode current collector 22 and the inclined surface S2 is shorter than the width Le of the end part A2 of the positive electrode active material layer 24. However, the width Lb may be the same as the width Le of the end part A2 of the positive electrode active material layer 24. Although not particularly limited, the width Lb may be about 10 μm or more, typically 20 μm or more, for example, 50 μm or more, or 100 μm or more, and may be about 5,000 μm or less, 3,000 μm or less, typically 2,000 μm or less, for example, 1,000 μm or less. A ratio (Lb/Le) of the width Lb to the width Le of the end part A2 may be about 0.1 or more, typically 0.2 to 0.8 (0.5±0.3), for example, 0.3 to 0.7 (0.5±0.2), or 0.4 to 0.6 (0.5±0.1). Thereby, it is possible to minimize metal deposition on the negative electrode 30 to a large degree and also it is possible to provide a large battery capacity. In addition, it is possible to stably form the insulating layer 26 with a width Lb. The upper end of a part in which the insulating layer 26 is provided is positioned at the same level as or lower than the upper end (surface) of the main body part A1.

As shown in FIG. 3, the positive electrode 20 includes, a stacking part B in which the insulating layer 26 inserted between the positive electrode current collector 22 and the inclined surface S2, the end part A2 of the positive electrode active material layer 24, and the insulating layer 26 overlaid on the inclined surface S1 are laminated in the thickness direction X, from the side closer to the positive electrode current collector 22. Here, the stacking part B has a structure having three vertical layers. Here, the width of the stacking part B is the same as the width Lb. Here, the maximum thickness of the stacking part B is smaller than the average thickness of the main body part A1. However, the maximum thickness of the stacking part B may be the same as the average thickness of the main body part A1. Here, the upper end of the stacking part B in the thickness direction X, in other words, the upper end of a part of the insulating layer 26 with the width Lb, is positioned lower than the upper end (surface) of the main body part A1.

In the present embodiment, the width La of the entire positive electrode active material layer 24 and the width Lb of the part of the insulating layer 26 inserted between the positive electrode current collector 22 and the inclined surface S2 satisfy the following Formula (1): 0.02×10⁻²≤(Lb/La)≤2.1×10⁻². The ratio (Lb/La) may be 1.0×10⁻² or less. The ratio (Lb/La) may satisfy the following Formula (2): 0.02×10⁻²≤(Lb/La)≤1.0×10⁻². Thereby, it is possible to suitably minimize an increase in resistance of the positive electrode 20 due to formation of the insulating layer 26.

The ratio (Lb/La) may be 0.48×10⁻² or more, and preferably 0.73×10⁻² or more, for example, 0.8×10⁻² or more. The ratio (Lb/La) may satisfy, for example, the following Formula (3): 0.73×10⁻²≤(Lb/La)≤2.1×10⁻²; and preferably the following Formula (4): 1.0×10⁻²≤(Lb/La)≤2.1×10⁻². Thereby, it is possible to effectively minimize elution of metallic elements from the end part A2, and it is possible to minimize metal deposition on the negative electrode 30 to a large degree.

The negative electrode 30 includes a negative electrode current collector 32 and the negative electrode active material layer 34 formed on the negative electrode current collector 32. The negative electrode current collector 32 is a conductive member. Regarding the negative electrode current collector 32, for example, a metal foil such as copper or nickel is suitable. The negative electrode current collector 32 has a part 32a in which the negative electrode active material layer 34 is not formed and the negative electrode current collector 32 is exposed (an exposed part of the negative electrode current collector). Here, the exposed part 32a of the negative electrode current collector is provided in a band shape at an end part of the negative electrode current collector 32 in the Y1 direction. As shown in FIG. 2, the exposed part 32a of the negative electrode current collector protrudes in the Y1 direction relative to an end of the separator 40 in the Y1 direction in a plan view. As shown in FIG. 1, a negative electrode current collecting plate 32b is bonded to the exposed part 32a of the negative electrode current collector. The negative electrode current collecting plate 32b is electrically connected to the negative electrode terminal 32c.

The negative electrode active material layer 34 is fixed to the surface of the negative electrode current collector 32. The negative electrode active material layer 34 contains a negative electrode active material that can reversibly occlude and release charge carriers. Examples of negative electrode active materials include carbon materials such as graphite, metal oxide materials such as titanium oxide, and lithium titanium composite oxide (LTO), and S1 materials containing silicon. These can be used alone or two or more thereof can be used in combination. The negative electrode active material layer 34 may contain optional components other than the negative electrode active material, for example, a conductive material, a binder, and a thickener. Regarding the conductive material, for example, carbon black such as acetylene black (AB) and other carbon materials can be suitably used. Regarding the binder, for example, styrene butadiene rubber (SBR) can be used. Regarding the thickener, for example, carboxymethyl cellulose (CMC) can be used.

As shown in FIG. 2 the negative electrode active material layer 34 extends in the longitudinal direction with a predetermined width Lf. The width La of the negative electrode active material layer 34 is wider than the width La of the positive electrode active material layer 24. That is, Lf>La. The negative electrode active material layer 34 protrudes in the Y1 direction relative to an end of the positive electrode active material layer 24 in the Y1 direction in a plan view. The negative electrode active material layer 34 protrudes in the Y2 direction relative to an end of the positive electrode active material layer 24 in the Y2 direction in a plan view.

The separator 40 insulates the positive electrode active material layer 24 of the positive electrode 20 from the negative electrode active material layer 34 of the negative electrode 30. Regarding the separator 40, for example, a porous resin sheet made of a resin such as polyethylene (PE), polypropylene (PP), a polyester, cellulose, or a polyamide, is suitable. The separator 40 may have a single-layer structure, or may have a structure in which two or more layers are laminated, for example, a three-layer structure in which a PP layer is laminated on both surfaces of a PE layer. For example, a heat resistant layer (HRL) containing the inorganic filler as a material constituting the insulating layer 26 may be provided on the surface of the separator 40.

As shown in FIG. 2, the width Ls of the separator 40 is wider than the width La of the positive electrode active material layer 24 and the width Lf of the negative electrode active material layer 34. That is, Ls>Lf>La. The separator 40 protrudes in the Y1 direction relative to an end of the positive electrode active material layer 24 in the Y1 direction and an end of the negative electrode active material layer 34 in the Y1 direction in a plan view. The separator 40 protrudes in the Y2 direction relative to an end of the positive electrode active material layer 24 in the Y2 direction, an end of the insulating layer 26 in the Y2 direction, and an end of the negative electrode active material layer 34 in the Y2 direction in a plan view.

The non-aqueous electrolyte is, for example, a non-aqueous electrolytic solution containing a non-aqueous solvent and a supporting salt. Regarding the non-aqueous solvent, organic solvents such as various carbonates, ethers, and esters can be used. Among these, carbonates are preferable. Specific examples include ethylene carbonate (EC), propylene carbonate (PC), diethyl carbonate (DEC), dimethyl carbonate (DMC), ethyl methyl carbonate (EMC), monofluoroethylene carbonate (MFEC), and difluoroethylene carbonate (DFEC). These non-aqueous solvents can be used alone or two or more thereof can be used in an appropriate combination. Regarding the supporting salt, for example, a lithium salt such as LiPF₆ and LiBF₄ can be used. The non-aqueous electrolyte may additionally contain various conventionally known additives, for example, overcharge additives such as biphenyl (BP) and cyclohexylbenzene (CHB), an oxalato complex compound containing boron atoms and/or phosphorus atoms, and a film forming agent such as vinylene carbonate (VC).

Here, the positive electrode 20 having the configuration can be produced by a production method including, for example, the following procedures: (Step S1) preparation of a paste for forming a positive electrode active material layer; (Step S2) preparation of a paste for forming an insulating layer; (Step S3) applying and drying the paste; and (Step S4) pressing a positive electrode. Here, (Step S4) is not essential and can be omitted in other embodiments. Hereinafter, description will be provided in order.

In (Step S1), a material such as the positive electrode active material is dispersed in an appropriate solvent (for example, N-methyl-2-pyrrolidone (NMP)) to prepare a paste for forming a positive electrode active material layer. The paste can be prepared using, for example, a stirring and mixing device such as a ball mill, a roll mill, a planetary mixer, a disper, or a kneader. In this case, the viscosity V1 of the paste for forming a positive electrode active material layer may be adjusted to be within the range of about 1,000 to 20,000 mPa·s, typically 5,000 to 10,000 mPa·s. The viscosity V1 can be adjusted, for example, by an amount of a solid content (for example, a binder or a dispersant) added with respect to the solvent, and kneading time of the paste. Thereby, it is possible to stably and accurately perform Step S3 to be described below. Here, in this specification, the “viscosity of a paste” is a value measured at 25° C. using a rheometer at a shear rate of 21.5 s⁻¹.

In (Step S2), a material such as the inorganic filler is dispersed in an appropriate solvent (for example, NMP) to prepare a paste for forming an insulating layer. In this case, the viscosity V2 of the paste for forming an insulating filler layer may be adjusted to be within the range of about 1,000 to 5,000 mPa·s, for example, 1,500 to 4,500 mPa·s. The viscosity V2 can be adjusted, for example, by an amount of a solid content (for example, a binder) added with respect to the solvent, and kneading time of the paste. Thereby, it is possible to stably and accurately perform Step S3 to be described below.

Here, in Step S3 to be described below, when a so-called simultaneous coating method is used, it is necessary to set the viscosity V2 of the paste for forming an insulating layer to be lower than the viscosity V1 of the paste for forming a positive electrode active material layer (low viscosity). Thereby, the contact angle with respect to the positive electrode current collector 22 becomes “paste for forming an insulating layer<paste for forming a positive electrode active material layer” and the paste for forming an insulating layer can be more easily wedged under the paste for forming a positive electrode active material layer. In addition, a ratio (V2/V1) of the viscosity V2 to the viscosity V1 may be adjusted to be within the range of about 0.01 to 0.99, typically 0.05 to 0.95. Thereby, the width of the stacking part B can be suitably adjusted to be within the above range.

In (Step S3), two types of pastes prepared in Steps S1 and S2 are applied to the positive electrode current collector 22 except for the end part of the positive electrode current collector 22 in the Y2 direction. The pastes can be applied using, for example, a coating device such as a die coater, a slit coater, a comma coater, or a gravure coater. In an example, the two types of pastes are applied sequentially in three stages. That is, first, the paste for forming an insulating layer is applied to the positive electrode current collector 22 with a predetermined width Lb except for the exposed part 22a of the positive electrode current collector. Next, the paste for forming a positive electrode active material layer is applied to the positive electrode current collector 22 and a part of the insulating layer 26 with a predetermined width La. Then, the paste for forming an insulating layer is applied again with a predetermined width Lc so that the entire end part A2 of the positive electrode active material layer 24 is covered. Alternatively, in another example, the two types of pastes are applied to the positive electrode current collector 22 using a die coater at the same time.

Although not shown, in a preferable aspect, a die coater including a transport mechanism that transports the positive electrode current collector 22 in a transport direction orthogonal to the width direction and a die head from which the two types of pastes are discharged to the positive electrode current collector 22 is prepared. The die head includes a first discharge unit having a first opening through which the paste for forming an insulating layer is discharged and a second discharge unit having a second opening through which the paste for forming a positive electrode active material layer is discharged. The widths of the first opening and the second opening are adjusted so that the positive electrode active material layer 24 and the insulating layer 26 have a predetermined width. For example, in consideration of wet spreadability with respect to the positive electrode current collector 22, the width may be adjusted slightly (for example, about 1% to 2%) smaller than the predetermined width. In addition, in consideration of the wet spreadability, and the like, a predetermined interval may be provided between the first opening and the second opening. In addition, in the transport direction, the second discharge unit may be positioned slightly downstream from the first discharge unit. Thereby, the paste for forming an insulating layer can be discharged slightly sooner than the paste for forming a positive electrode active material layer. The first discharge unit, the second discharge unit and the transport mechanism are each electrically connected to a control device. The control device transports the positive electrode current collector 22 in the transport direction and discharges a paste at a predetermined discharge pressure from each of the first discharge unit and the second discharge unit. The positive electrode current collector 22 to which the paste for forming an insulating layer and the paste for forming a positive electrode active material layer are attached may be dried using, for example, a heating dryer.

In (Step S4), press processing is performed on the positive electrode current collector 22 to which the two types of pastes are attached. Thereby, it is possible to adjust properties of the positive electrode active material layer 24 and/or the insulating layer 26, for example, a thickness, a density, and the like. As described above, as shown in FIG. 3, it is possible to produce the positive electrode 20 including the positive electrode active material layer 24 and the insulating layer 26 on the positive electrode current collector 22.

FIG. 4 is an explanatory diagram for describing movement of electrons and Li between the positive electrode 20 and the negative electrode 30. As shown in FIG. 4, in the lithium ion secondary battery 100, supply of electrons (e⁻) to the end part of the positive electrode active material layer 24, here, the stacking part B, is minimized by the insulating layer 26, and a charging and discharging reaction in the stacking part B is minimized. Thereby, movement of charge carriers (here, Li⁺) from the end part A2 including the stacking part B is restricted. As a result, the end part A2 is less likely to be exposed to a high potential, and it is possible to minimize elution of metallic elements from the end part A2. Therefore, according to the lithium ion secondary battery 100 having the configuration, it is possible to reduce metal deposition (for example, Li deposition) on the facing negative electrode 30 and it is possible to realize excellent Li deposition resistance. In addition, it is possible to realize a battery having excellent durability.

While the lithium ion secondary battery 100 can be used for various applications, a high energy density and a large capacity can be realized when the wound electrode body 10 is provided. In addition, when the positive electrode 20 has the configuration, deposition resistance (for example, Li deposition resistance) of a substance derived from charge carriers is improved, and cycle characteristics are improved, compared to a conventional product. Therefore, using such a feature, the battery can be suitably used as a drive power supply mounted in vehicles such as an electric vehicle (EV), a hybrid vehicle (HV), and a plug-in hybrid vehicle (PHV).

In addition, in the present embodiment, the rectangular lithium ion secondary battery 100 including the flat wound electrode body 10 has been described as an example. However, the lithium ion secondary battery can be configured as a lithium ion secondary battery including a lamination type electrode body. In addition, the outside shape of the lithium ion secondary battery 100 can be a cylindrical shape, a laminated type, or the like. In addition, the technology disclosed here can be applied to a non-aqueous electrolyte secondary battery other than the lithium ion secondary battery.

Hereinafter, examples according to the present invention will be described, but the present invention is not intended to be limited to those described in these examples.

Production of Positive Electrode

LiNi_{1/3}Co_{1/3}Mn_{1/3}O₂ as a positive electrode active material, lithium phosphate (Li₃PO₄), polyvinylidene fluoride (PVdF) as a binder, and acetylene black (AB) as a conductive material were mixed in N-methyl-2-pyrrolidone (NMP) to prepare a paste for forming a positive electrode active material layer. In addition, boehmite as an inorganic filler and polyacrylic acid as a binder were mixed into NMP to prepare a paste for forming an insulating layer. In this case, a ratio (V2/V1) of the viscosity V2 of the paste for forming an insulating layer to the viscosity V1 of the paste for forming a positive electrode active material layer was adjusted as shown in Table 1.

Next, a band-like aluminum foil was prepared as a positive electrode current collector. Then, the prepared paste for forming a positive electrode active material layer and paste for forming an insulating layer were applied to the aluminum foil at the same time using a die coater, dried and then pressed. Here, the paste was applied to the aluminum foil in the longitudinal direction except for an exposed part of the current collector at the end of the aluminum foil. In addition, the width La of the positive electrode active material layer was about 100 mm. In this manner, positive electrodes (Examples 1 to 5, and Comparative Example 1) including the positive electrode active material layer and the insulating layer were produced.

In addition, for comparison, a paste for forming an insulating layer with a predetermined width was applied to a positive electrode current collector except for an exposed part of the positive electrode current collector, and a paste for forming a positive electrode active material layer was then applied to the positive electrode current collector and a part of the insulating layer with the predetermined width La to produce a positive electrode (Comparative Example 2). In addition, only the paste for forming a positive electrode active material layer was applied to the positive electrode current collector with a predetermined width La except for the exposed part of the positive electrode current collector, and thereby a positive electrode (Comparative Example 3) not coated with an insulating layer was produced.

Observation of Structure of Positive Electrode

The positive electrodes (Examples 1 to 5, and Comparative Examples 1 and 2) were cut along the width direction and test pieces were cut out. The test pieces were embedded and polished, and the cross sections of the insulating layer and the positive electrode active material layer were then observed using a scanning electron microscope (SEM), and observation images (observation magnification: 500 to 3,000×) were obtained. In this case, an image with clear contrast was obtained by setting the acceleration voltage to 10 kV. As a result, the positive electrodes of Examples 1 to 5 had a configuration schematically shown in FIG. 3. That is, in Examples 1 to 5, the positive electrode 20 included the exposed part 22a of the positive electrode current collector, the positive electrode active material layer 24, the insulating layer 26, and the stacking part B. In addition, in the positive electrode of Comparative Example 1, the inclined surface S2 was in contact with the positive electrode current collector 22 while the inclined surface S1 was covered with the insulating layer 26. That is, the insulating layer 26 was not inserted between the positive electrode current collector 22 and the inclined surface S2 of the positive electrode active material layer 24. In the positive electrode of Comparative Example 1, the width Lb of the part of the insulating layer 26 inserted between the positive electrode current collector 22 and the inclined surface S2 was 0, and the ratio (Lb/La) was also 0. In addition, in the positive electrode of Comparative Example 2, the insulating layer 26 was not overlaid on the inclined surface S1 while the inclined surface S2 was covered with the insulating layer 26. That is, the inclined surface S1 was exposed on the surface.

Measurement of Lb

Next, the width Lb was determined from the observation images of the positive electrodes (Examples 1 to 5). Specifically, a distance between the end of the insulating layer in the Y2 direction and the end of the positive electrode active material layer in the Y1 direction was measured as the width Lb. Here, in consideration of variation in the longitudinal direction, the width Lb was measured at three to five parts for each of the examples, and an arithmetic average value thereof was obtained. In Examples 1 to 5, the width Lb was in a range of 20 to 2,000 μm. In Examples 1 to 4, the width Lb was in a range of 20 to 1,000 μm. Then, Lb/La was calculated from the width Lb and the width La. The results are shown in Table 1.

Production of Lithium Ion Secondary Battery

Natural graphite (C) as a negative electrode active material, styrene butadiene rubber (SBR) as a binder, and carboxymethyl cellulose (CMC) as a thickener were mixed in deionized water to prepare a paste for forming a negative electrode active material layer. Next, a band-like copper foil was prepared as a negative electrode current collector. Then, the negative electrode paste was applied to both surfaces of the copper foil, dried and then pressed. In this manner, a negative electrode including the negative electrode active material layer was produced.

Next, regarding a separator, a porous polyolefin sheet having a three-layer structure of PP/PE/PP in which a polypropylene layer (PP layer) was laminated on both sides of a polyethylene layer (PE layer) was prepared. Then, the produced positive electrode and negative electrode were laminated with the separator therebetween to produce electrode bodies (Examples 1 to 5, and Comparative Examples 1 to 3). Next, the positive electrode current collecting plate was welded to the positive electrode of the produced electrode body and the negative electrode current collecting plate was welded to the negative electrode and they were accommodated in a battery case.

Next, regarding a non-aqueous electrolytic solution, a solution in which LiPF₆ with a concentration of 1.0 mol/L as a supporting salt was dissolved in a mixed solvent containing ethylene carbonate (EC), ethyl methyl carbonate (EMC), and dimethyl carbonate (DMC) was prepared. Then, the non-aqueous electrolytic solution was injected into the battery case, and the battery case was hermetically sealed. Thereby, lithium ion secondary batteries (Examples 1 to 5, and Comparative Examples 1 to 3) were produced.

Initial Charging and Discharging

Constant current charging was performed on the produced lithium ion secondary battery at a rate of ⅓ C until the voltage reached 4.2 V at 25° C., and constant voltage charging was then performed until the current reached 1/50 C. Next, constant current discharging was performed at a rate of ⅓ C until the voltage reached 3.0 V. Here, “1 C” refers to a current value at which a battery capacity (Ah) predicted from a theoretical capacity of a positive electrode active material can be charged in 1 hour.

Evaluation of Amount of Mn in Negative Electrode After Cycle Test

The charging and discharging were set as one cycle, and charging and discharging were repeated over 1,000 cycles. Then, the lithium ion secondary battery after charging and discharging was disassembled and the negative electrode was taken out. Next, a part facing the stacking part B of the positive electrode was separated into a size of 100 mm×100 mm. Next, the negative electrode current collector was peeled off from the separated negative electrode, and the negative electrode active material layer was dispersed in an acidic solvent. Regarding the acidic solvent, a solvent in which hydrogen peroxide was added to a mixed acid containing hydrochloric acid and nitric acid was used. Then, through inductively coupled plasma (ICP) analysis, Mn contained in the dispersion solution was quantified. The results are shown in Table 1. Here, Table 1 shows relative values when the amount of Mn in Comparative Example 1 is set as 100. For the amount of Mn in Table 1, a smaller numerical value indicates further minimized deposition of Mn.

Evaluation of Durability After High Rate Cycling

The lithium ion secondary battery after the cycle test was put into a constant temperature chamber at −6.7° C. and the temperature was sufficiently stabilized. Next, high rate charging and discharging was additionally repeated over 300 cycles under an environment at −6.7° C. High rate charging and discharging conditions were as follows: charging was performed at a constant current of 200 A for 5 seconds and discharging was then performed at a constant current of 200 A for 5 seconds. Then, a capacity retention ratio was determined from the battery capacity before and after high rate cycling. The results are shown in Table 1. Here, Table 1 shows relative values when the capacity retention ratio in Comparative Example 1 is set as 100. For the capacity retention ratio in Table 1, a larger numerical value indicates lower deterioration of the capacity after high rate cycling, and better Li deposition resistance.

Measurement of Resistance of Positive Electrode

The lithium ion secondary battery after the initial charging and discharging was disassembled and the positive electrode was taken out. This was made to face Li metal, and accommodated in a laminated bag-like container together with a non-aqueous electrolytic solution to construct a laminate cell. Next, the laminate cell was put into a constant temperature chamber at −30° C. and the temperature was sufficiently stabilized. Next, the IV resistance of the laminate cell was measured under an environment at −30° C. The results are shown in Table 1. Here, Table 1 shows relative values when the IV resistance in Comparative Example 1 is set as 100. For the positive electrode resistance in Table 1, a smaller numerical value indicates lower resistance.

TABLE 1

| | | | Evaluation result (relative value | | |
|---|---|---|---|---|---|
| | | | based on Comparative Example 1) | | |
| | | | Amount of | | |
| | | | Mn in | | |
| | Positive electrode | | negative | Durability | Resistance of |
| | Viscosity | | electrode | after high rate | positive |
| Test example | ratio V2/V1*¹ | Lb/La | after cycling | cycling | electrode |
| Example 1 | 0.95 | 0.02 × 10⁻² | 99 | 101 | 100 |
| Example 2 | 0.54 | 0.48 × 10⁻² | 99 | 103 | 100 |
| Example 3 | 0.40 | 0.73 × 10⁻² | 96 | 106 | 100 |
| Example 4 | 0.28 | 1.0 × 10⁻² | 95 | 106 | 100 |
| Example 5 | 0.094 | 2.1 × 10⁻² | 95 | 106 | 105 |
| Comparative | 1.08 | 0 | 100 (reference) | | |
| Example 1 | | | | | |
| Comparative | Not measured | — | 99 | 100 | 100 |
| Example 2*² | | | | | |

| | | | | |
|---|---|---|---|---|
| Comparative | — | 103 | 95 | 100 |
| Example 3*³ | | | | |

*¹value measured at 25° C. using a rheometer at a shear rate of 21.5 (s⁻¹).
*²an inclined surface S1 was exposed
*³an insulating layer was not coated

FIG. 5 is a graph showing the relationship between the viscosity ratio (V2/V1) of the paste and Lb/La. As shown in Table 1 and FIG. 5, when a simultaneous coating method was used, it was possible to suitably form the width Lb and adjust the length thereof by changing the viscosity ratio (V2/V1). Here, when the viscosity ratio (V2/V1) was controlled so that it was less than 1, specifically, in a range of 0.094 to 0.95, Lb/La could be in a range of 0.02×10⁻² to 2.1×10⁻².

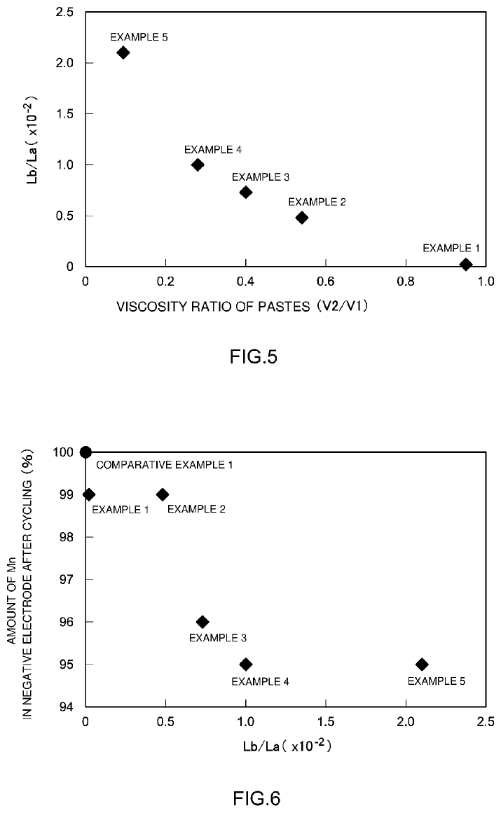

FIG. 6 is a graph showing the relationship between Lb/La and the amount of Mn in the negative electrode after cycling. As shown in Table 1 and FIG. 6, in Examples 1 to 5 in which Lb/La was 0.02×10⁻² or more, elution of Mn from the positive electrode active material was minimized compared to Comparative Examples 1 to 3. In particular, when Lb/La was set to 0.7×10⁻² or more, preferably, 1×10⁻² or more, this effectively minimized elution of Mn from the positive electrode active material.

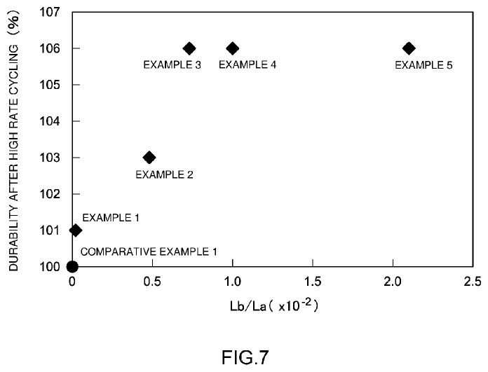

FIG. 7 is a graph showing the relationship between Lb/La and durability after high rate cycling. As shown in Table 1 and FIG. 7, in Examples 1 to 5 in which Lb/La was 0.02×10⁻² or more, the occurrence of Li deposition on the negative electrode was minimized, and a large battery capacity after high rate cycling was maintained compared to Comparative Examples 1 to 3. In particular, when Lb/La was set to 0.4×10⁻² or more, preferably, 0.7×10⁻² or more, Li deposition resistance was improved, and an effect of minimizing deterioration of the capacity was suitably exhibited.

In addition, as shown in Table 1, in Examples 1 to 4 in which Lb/La was less than 2.1×10⁻², for example, 2×10⁻² or less, it was possible to minimize an increase in resistance of the positive electrode due to formation of the insulating layer.

While the present invention has been described above in detail, the embodiment and examples are only examples, and the invention disclosed here includes various modifications and alterations of the specific examples.

The terms and expressions used herein are for description only and are not to be interpreted in a limited sense. These terms and expressions should be recognized as not excluding any equivalents to the elements shown and described herein and as allowing any modification encompassed in the scope of the claims. The preferred embodiments disclosed herein may be embodied in many various forms. This disclosure should be regarded as providing preferred embodiments of the principle of the invention. These preferred embodiments are provided with the understanding that they are not intended to limit the invention to the preferred embodiments described in the specification and/or shown in the drawings. The invention is not limited to the preferred embodiment described herein. The invention disclosed herein encompasses any of preferred embodiments including equivalent elements, modifications, deletions, combinations, improvements and/or alterations which can be recognized by a person of ordinary skill in the art based on the disclosure. The elements of each claim should be interpreted broadly based on the terms used in the claim, and should not be limited to any of the preferred embodiments described in this specification or used during the prosecution of the present application.

What is claimed is:

1. A non-aqueous electrolyte secondary battery, comprising:
a positive electrode;
a negative electrode that faces the positive electrode; and
a non-aqueous electrolyte, wherein
the positive electrode includes
a positive electrode current collector,
a positive electrode active material layer which contains a positive electrode active material and is formed on the positive electrode current collector except for a part in which the positive electrode current collector is exposed, and
an insulating layer which contains an inorganic filler and is formed at a boundary part between the part in which the positive electrode current collector is exposed and the positive electrode active material layer,
the positive electrode active material layer includes a main body part and an end part which is provided closer to the part in which the positive electrode current collector is exposed than the main body part and has a smaller thickness than a thickness of the main body part,
the insulating layer is inserted between the positive electrode current collector and the end part in a thickness direction and is formed so as to cover the end part, and
when a width of the positive electrode active material layer is set as La, and a width of a part of the insulating layer inserted between the positive electrode current collector and the end part is set as Lb in a direction from the positive electrode active material layer to the insulating layer, the width La and the width Lb satisfy the following Formula (1):
0.02×10⁻²≤(Lb/La)≤2.1×10⁻².

2. The non-aqueous electrolyte secondary battery according to claim 1, wherein the width La and the width Lb satisfy the following Formula (2):
0.02×10⁻²≤(Lb/La)≤1.0×10⁻².

3. The non-aqueous electrolyte secondary battery according to claim 1, wherein the width Lb is 20 μm or more and 2,000 μm or less.

4. The non-aqueous electrolyte secondary battery according to claim 1, wherein
when a width of the main body part is set as Lm and a width of the end part is set as Le, a ratio (Le/Lm) of the width Le to the width Lm is 0.1 or less.

5. The non-aqueous electrolyte secondary battery according to claim 1, wherein
when a width of the end part is set as Le, a ratio (Lb/Le) of the width Lb to the width Le is 0.2 or more and 0.8 or less.

6. The non-aqueous electrolyte secondary battery according to claim 1, wherein
in the thickness direction, an upper end of a part of the insulating layer with the width Lb is positioned lower than an upper end of the main body part.
